(19) United States
(12) Patent Application Publication
(10) Pub. No.: US 2023/0089305 A1
(43) Pub. Date: Mar. 23, 2023

(54) AUTOMATED NAMING OF AN APPLICATION/TIER IN A VIRTUAL COMPUTING ENVIRONMENT

(71) Applicant: VMware, Inc., Palo Alto, CA (US)

(72) Inventors: Madan SINGHAL, Pune (IN); Deepak GANGWAR, Uttar Pradesh (IN); Shubhrajyoti MOHAPATRA, Odisha (IN)

(73) Assignee: VMware, Inc., Palo Alto, CA (US)

(21) Appl. No.: 17/410,930

(22) Filed: Aug. 24, 2021

(51) Int. Cl. G06F 16/16; G06F 16/188; G06F 16/17; G06F 40/284

(52) U.S. Cl. CPC G06F 16/166; G06F 16/188; G06F 16/1734; G06F 40/284

(57) ABSTRACT

Automated provision and assignment of meaningful business names for auto discovered Applications and Tiers is disclosed. Properties of members of a virtual computing environment are automatically determined. Performing a tokenization process on text corresponding to the members to obtain information from the text. Utilizing a document generation operation to obtain tokens from the text. Performing a text mining operation on the text to obtain Term Frequency (TF) data, Document Frequency (DF) information, an Inverse Document Frequency (IDF), and TF-IDF data, and utilizing the TF-IDF data to automatically generate and assign a name to the Application/Tiers of said virtual computing environment.

### BACKGROUND ART

Distributed computing platforms, such as in networking products (NP) provided by VMware, Inc., of Palo Alto, Calif. (VMware) include software that allocates computing tasks across group or cluster of distributed software components executed by a plurality of computing devices, enabling large data sets to be processed more quickly than is generally feasible with a single software instance or a single device. Such platforms typically utilize a distributed file system that can support input/output intensive distributed software component running on a large quantity (e.g., thousands) of computing devices to access large quantity of data. For example, the NP distributed file system (HDFS) is typically used in conjunction with NP—a data set to be analyzed by NP may be stored in as a large file on HDFS which enables various computing devices running NP software to simultaneously process different portions of the file.

Typically, distributed computing platforms such as NP are configured and provisioned in a “native” environment, where each “node” of the cluster corresponds to a physical computing device. In such native environment, where each “node” of the cluster corresponds to a physical computing device. In such native environments, administrators typically need to manually configure the settings for the distributed computing platform by generating and editing configuration or metadata files that, for example, specify the names and network addresses of the nodes in the cluster, as well as whether any such nodes perform specific functions for the distributed computing platform. More recently, service providers that offer cloud-based Infrastructure-as-a-Service (LaaS) offerings have begun to provide customers with NP frameworks as a “Platform-as-a-Service” (PaaS).

Such PaaS based NP frameworks however are limited, for example, in their configuration flexibility, reliability and robustness, scalability, quality of service (QoS) and security. These platforms also have the further problem of being able to handle disparate computing endpoints with huge volume of application is a very efficient discoverable manner.

Accurate and comprehensive application awareness (boundary, components, dependencies) is a pre-requisite for effectively driving many data-center operations workflows, including micro-segmentation security planning network troubleshooting, applications performance optimization, application migration.

Manual classification of endpoints (e.g., virtual machines) to applications and tiers is a cumbersome and error-prone process and its quality depends on many factors including proper assignment of attributes (name, tag, etc.) to an endpoint. Besides, to validate such classification, one needs to analyze the network communication pattern among these groups. Also, with the regular influx of new endpoints in the data center, the classification needs to be continually updated. This process is not practical for an environment with thousands of applications.

Automated and continuous discovery of applications (and tiers) addresses these concerns as it requires fewer manual efforts and can dynamically adapt.

The complexity of application discovery increases with the diversity of applications that can exist in a data center. A data center can comprise of simple as well as relatively complex applications that co-exist and interact with each other. The existence of common services like AD, DNS, etc., complicates the task of identifying application boundaries. FIG. 1 is an example of a topology with applications and common services. In FIG. 1, each circle represents a virtual or physical endpoint. Different applications and common services groups have been grouped differently to demarcate them properly. As can be seen from the topology shown in FIG. 1, it appears very difficult to track, monitor and trace where applications exist and what their boundaries are.

Current conventional discoveries to automated discovery suffer from the following drawbacks: (a) any agent-based solution that requires the installation of agents at the hypervisor or operating system level is quite intrusive in nature and can pose security challenges, (b) some of the agentless solutions require pervasive access to all servers in order to execute appropriate commands to collect information related to processes, connections, etc. This is not ideal from a security or performance perspective.

It should also be noted that most computing environments, including virtual network environments are not static. That is, various machines or components are constantly being added to, or removed from, the computer environment. As such changes are made to the computing environment, it is frequently necessary to amend or change which of the various machines or components (virtual and/or physical) are registered with the security system. And even in a perfectly laid out network environment the introduction of components and machines is bound to introduce segmentations and hairpins which affect the performance of the network. These performance problems are more exacerbated in the virtual computing environment with heavy network traffic between them.

In conventional approaches to discovery and monitoring of services and applications in a computing environment, constant and difficult upgrading of agents is often required. Thus, conventional approaches for application and service discovery and monitoring are not acceptable in complex and frequently revised computing environments.

Additionally, many conventional security systems require every machine or component within a computing environment be assigned to a particular scope and service group so that the intended states can be derived from the service type. As the size and complexity of computing environments increases, such a requirement may require a high-level system administrator to manually register as many as thousands (or many more) of the machines or components (such as, for example, virtual machines) with the security system.

Thus, such conventionally mandated registration of the machines or components is not a trivial job. This burden of manual registration is made even more burdensome considering that the target users of many security systems are often experienced or very high-level personnel such as, for example, Chief Information Security Officers (CISOs) and their teams who already have heavy demands on their time.

Furthermore, even such high-level personnel may not have full knowledge of the network topology of the computing environment or understanding of the functionality of every machine or component within the computing environment. Hence, even when possible, the time and/or person-hours necessary to perform and complete such a conventionally required configuration for a computing system can extend to days, weeks, months or even longer.

Moreover, even when such conventionally required manual registration of the various machines or components is completed, it is not uncommon that entities, including the aforementioned very high-level personnel, have failed to properly assign the proper scopes and services to the various machines or components of the computing environment. Furthermore, in conventional computing systems, it not uncommon to find such improper assignment of scopes and services to the various machines or components of the computing environment even after a conventional computing system has been operational for years since its initial deployment. As a result, such improper assignment of the scopes and services to the various machines or components of the computing environment may have significantly and deleteriously impacted the accessibility by applications and the overall performance of conventional computing systems even for a prolonged duration.

Furthermore, as stated above, most computing environments, including machine learning environments are not static. That is, various machines or components are constantly being added to, or removed from, the computing environment. As such changes are made to the computing environment, it is necessary to review the changed computing environment and once again assign the proper scopes and services to the various machines or components of the newly changed computing environment. Hence, the aforementioned overhead associated with the assignment of scopes and services to the various machines or components of the computing environment will not only occur at the initial phase when deploying a conventional security system, but such aforementioned overhead may also occur each time the computing environment is expanded, updated, or otherwise altered. This includes instances in which the computing environment is altered, for example, by expanding, updating, or otherwise altering, for example, the roles of machine or components including, but not limited to, virtual machines of the computing environment.

Thus, conventional approaches for providing application discovery in a distributed computing platform with a large number of disparate components and applications of a computing environment, including a machine learning environment, are highly dependent upon the skill and knowledge of a system administrator. Also, conventional approaches for providing learning to machines or components of a computing environment, are not acceptable in complex and frequently revised computing environments.

Additionally, current enterprises and virtual infrastructure (VI) and network administrators prefer to plan and troubleshoot, for example, but not limited to, datacenters using business Applications and Tiers. Utilizing Applications and Tiers advantageously provides an abstraction level to manage infrastructure, resources and security planning.

Although many of the embodiments provided herein describe various auto discovery of Applications and Tiers it has now become important to have an appropriate and meaningful business name provided and assigned to the auto discovered Applications and Tiers.

### BRIEF DESCRIPTION OF THE DRAWINGS

The accompanying drawings, which are incorporated in and form a part of this specification, illustrate embodiments of the present technology and, together with the description, serve to explain the principles of the present technology.

FIG. 1 shows an example of a conventional data center application topology with common services;

FIG. 2 shows an example computer system upon which embodiments of the present invention can be implemented, in accordance with an embodiment of the present invention

FIG. 3 is a block diagram of an exemplary virtual computing network environment, in accordance with an embodiment of the present invention

FIG. 4A is a high-level block diagram showing an example of work-flow approach of one embodiment of the present invention.

FIG. 4B is a high-level block diagram of a software-defined network in accordance with one embodiment of the present invention.

FIG. 5 is a block diagram showing an example of different functions of the machine learning based application discovery method of one embodiment, in accordance with an embodiment of the present invention.

FIG. 6 is a flow diagram of one embodiment of the application discovery method, in accordance with an embodiment of the present invention.

FIG. 7 is a topology diagram of an example of an application cluster detected in applying the application discovery method, in accordance with an embodiment of the present invention.

FIG. 8 is a topology diagram of an exemplary multi-tiered application discovery for a virtual computing network environment, in accordance with an embodiment of the present invention.

FIG. 9 is a workflow diagram of actions performed to assign meaningful business names to auto discovered Applications and Tiers, in accordance with an embodiment of the present invention.

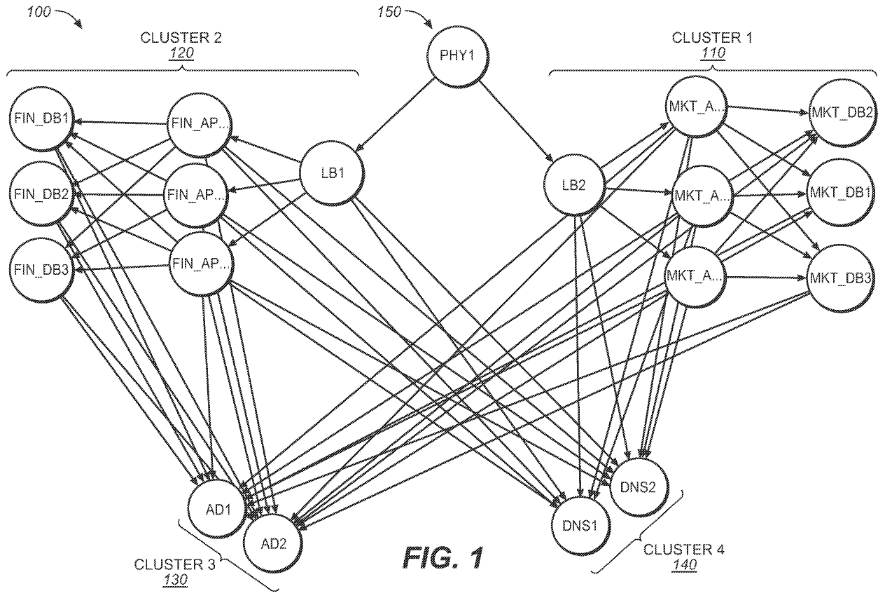

The drawings referred to in this description should not be understood as being drawn to scale except if specifically noted.

### DETAILED DESCRIPTION OF EMBODIMENTS

Reference will now be made in detail to various embodiments of the present technology, examples of which are illustrated in the accompanying drawings. While the present technology will be described in conjunction with these embodiments, it will be understood that they are not intended to limit the present technology to these embodiments. On the contrary, the present technology is intended to cover alternatives, modifications and equivalents, which may be included within the spirit and scope of the present technology as defined by the appended Claims. Furthermore, in the following description of the present technology, numerous specific details are set forth in order to provide a thorough understanding of the present technology. In other instances, well-known methods, procedures, components, and circuits have not been described in detail as not to unnecessarily obscure aspects of the present technology.

### Notation and Nomenclature

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities take the form of electrical or magnetic signals capable of being stored, transferred, combined, compared, and otherwise manipulated in an electronic device.

It should be borne in mind, however, that all of these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “displaying”, “identifying”, “generating”, “deriving”, “providing,” “utilizing”, “determining,” or the like, refer to the actions and processes of an electronic computing device or system such as: a host processor, a processor, a memory, a virtual storage area network (VSAN), virtual local area networks (VLANS), a virtualization management server or a virtual machine (VM), among others, of a virtualization infrastructure or a computer system of a distributed computing system, or the like, or a combination thereof. The electronic device manipulates and transforms data, represented as physical (electronic and/or magnetic) quantities within the electronic device's registers and memories, into other data similarly represented as physical quantities within the electronic device's memories or registers or other such information storage, transmission, processing, or display components.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the Figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example mobile electronic device described herein may include components other than those shown, including well-known components.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structures or any other structure suitable for implementation of the techniques described herein. In addition, in some embodiments, the functionality described herein may be provided within dedicated software modules or hardware modules configured as described herein. Also, the techniques could be fully implemented in one or more circuits or logic elements. A general-purpose processor may be a microprocessor, but in the alternative, the processor may be any conventional processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration.

The following terms will be frequently used throughout the application
(a) Tier: A tier is a collection of endpoints based on a certain role (e.g., a tier comprising of database endpoints.
(b) Application: An application is a collection of tiers, e.g., a simple application comprising web, app and database tiers;
(c) Hosted Port: It is a port exposed by an endpoint by the virtue of hosting a service, e.g., port 443 exposed by endpoints of web tier;
(d) Accessed Port: It is the port accessed by an endpoint consuming a service hosted on a server in the datacenter. e.g., port 389 accessed by endpoints consuming LDAP services;
(e) Communication Profile: Communication profile of an endpoint is the snapshot of incoming and outgoing connections (including endpoints at other ends) with respect to the endpoint; and
(f) Communication Density: For a group of endpoints, the communication density is directly proportional to the degree of connectivity among the nodes of the group.

### Example Computer System Environment

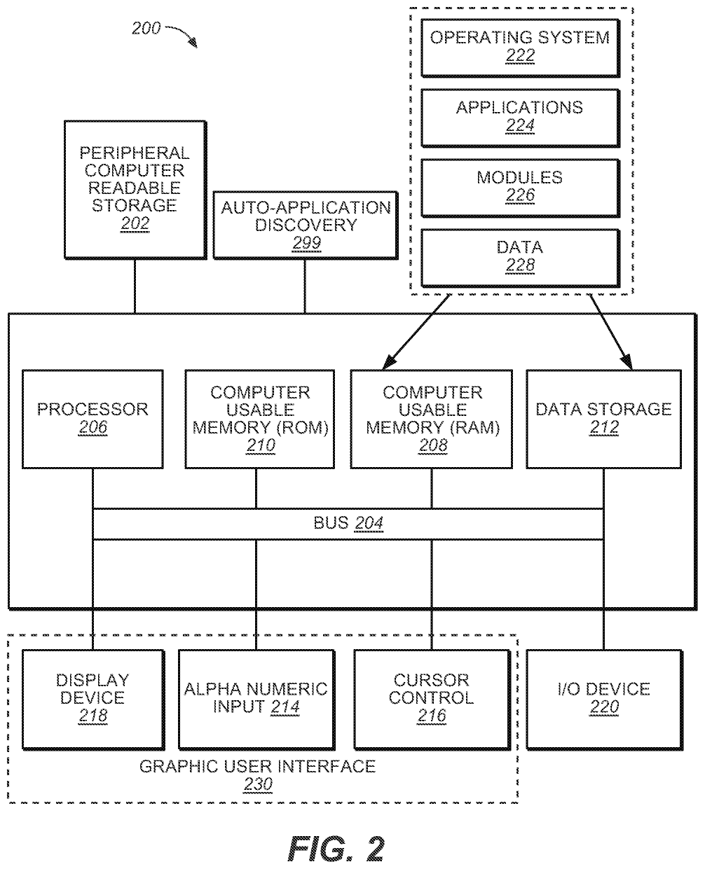

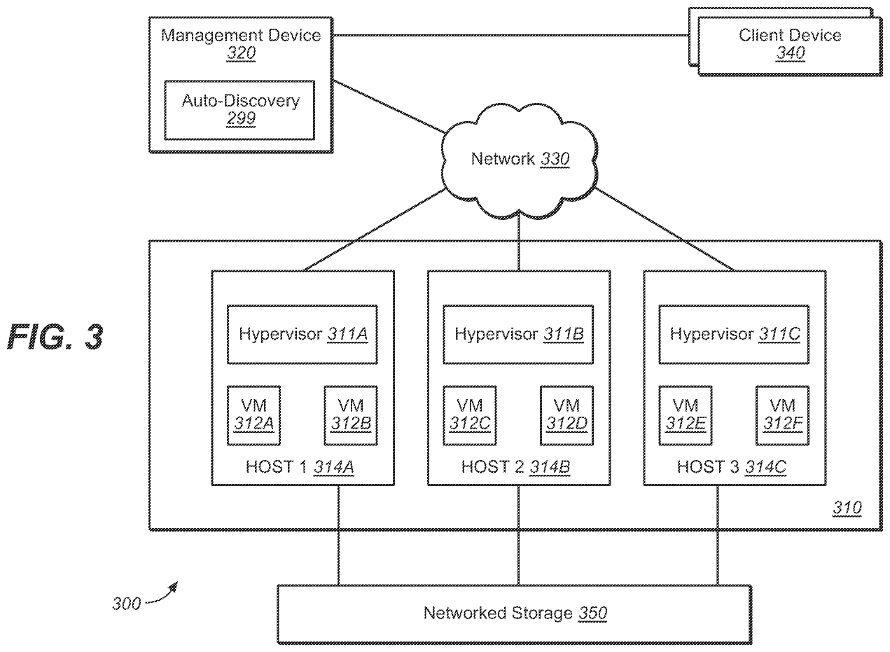

With reference now to FIG. 2, all or portions of some embodiments described herein are composed of computer-readable and computer-executable instructions that reside, for example, in computer-usable/computer-readable storage media of a computer system. That is, FIG. 2 illustrates one example of a type of computer (computer system 200) that can be used in accordance with or to implement various embodiments which are discussed herein. It is appreciated that computer system 200 of FIG. 2 is only an example and that embodiments as described herein can operate on or within a number of different computer systems including, but not limited to, general purpose networked computer systems, embedded computer systems, routers, switches, server devices, client devices, various intermediate devices/nodes, standalone computer systems, media centers, handheld computer systems, multi-media devices, virtual machines, virtualization management servers, and the like. Computer system 200 of FIG. 3 is well adapted to having peripheral tangible computer-readable storage media 202 such as, for example, an electronic flash memory data storage device, a floppy disc, a compact disc, digital versatile disc, other disc based storage, universal serial bus “thumb” drive, removable memory card, and the like coupled thereto. The tangible computer-readable storage media is non-transitory in nature.

System 200 of FIG. 2 includes an address/data bus 204 for communicating information, and a plurality of processor 206 coupled with bus 204 for processing information and instructions. As depicted in FIG. 2, system 200 is also well suited to a multi-processor environment in which a plurality of processors 206 are present. Conversely, system 200 is also well suited to having a single processor such as, for example, processor 206. Processor 206 may be any of various types of microprocessors. System 200 also includes data storage features such as a computer usable volatile memory 208, e.g., random access memory (RAM), coupled with bus 204 for storing information and instructions for processor 206.

System 200 also includes computer usable non-volatile memory 210, e.g., read only memory (ROM), coupled with bus 204 for storing static information and instructions for processor 206. Also present in system 100 is a data storage unit 212 (e.g., a magnetic or optical disc and disc drive) coupled with bus 204 for storing information and instructions. System 200 also includes an alphanumeric input device 214 including alphanumeric and function keys coupled with bus 204 for communicating information and command selections to one or more of processor 206. System 200 also includes a cursor control device 216 coupled with bus 204 for communicating user input information and command selections to one or more of processor 206. In one embodiment, system 200 also includes a display device 218 coupled with bus 204 for displaying information.

Referring still to FIG. 2, display device 218 of FIG. 2 may be a liquid crystal device (LCD), light emitting diode display (LED) device, cathode ray tube (CRT), plasma display device, a touch screen device, or other display device suitable for creating graphic images and alphanumeric characters recognizable to a user. Cursor control device 216 allows the computer user to dynamically signal the movement of a visible symbol (cursor) on a display screen of display device 218 and indicate user selections of selectable items displayed on display device 218.

Many implementations of cursor control device 216 are known in the art including a trackball, mouse, touch pad, touch screen, joystick or special keys on alphanumeric input device 214 capable of signaling movement of a given direction or manner of displacement. Alternatively, it will be appreciated that a cursor can be directed and/or activated via input from alphanumeric input device 214 using special keys and key sequence commands. System 200 is also well suited to having a cursor directed by other means such as, for example, voice commands. In various embodiments, alpha-numeric input device 214, cursor control device 216, and display device 218, or any combination thereof (e.g., user interface selection devices), may collectively operate to provide a graphical user interface (GUI) 230 under the direction of a processor (e.g., processor 206). GUI 230 allows user to interact with system 200 through graphical representations presented on display device 218 by interacting with alpha-numeric input device 214 and/or cursor control device 216.

System 200 also includes an I/O device 220 for coupling system 200 with external entities. For example, in one embodiment, I/O device 220 is a modem for enabling wired or wireless communications between system 200 and an external network such as, but not limited to, the Internet.

Referring still to FIG. 2, various other components are depicted for system 200. Specifically, when present, an operating system 222, applications 224, modules 226, and data 228 are shown as typically residing in one or some combination of computer usable volatile memory 208 (e.g., RAM), computer usable non-volatile memory 210 (e.g., ROM), and data storage unit 212. In some embodiments, all or portions of various embodiments described herein are stored, for example, as an application 224 and/or module 226 in memory locations within RAM 208, computer-readable storage media within data storage unit 212, peripheral computer-readable storage media 202, and/or other tangible computer-readable storage media.

### Brief Overview

First, a brief overview of an embodiment of the present machine learning based application discovery using netflow information invention, is provided below. Various embodiments of the present invention provide a method and system for automated feature selection within a machine learning within a virtual machine computing network environment.

More specifically, the various embodiments of the present invention provide a novel approach for automatically providing identifying communication patterns between virtual machines (VMs) of different instantiations in a virtual computing network environment to discover applications and tiers of the applications across various components in order to improve access and optimize network traffic by clustering application with a common host in the computing environment. In one embodiment, an IT administrator (or other entity such as, but not limited to, a user/company/organization etc.) registers multiple number of machines or components, such as, for example, virtual machines onto a network system platform, such as, for example, virtual networking products from VMware, Inc. of Palo Alto.

In the present embodiment, the IT administrator is not required to generate agent-based application discovery through any extraneous operating system intrusions of the virtual machines with the corresponding service type or indicate the importance of the particular machine or component. Further, the IT administrator is not required to manually list only those machines or components which the IT administrator feels warrant protection from excessive network traffic utilization. Instead, and as will be described below in detail, in various embodiments, the present invention, will automatically determine which applications and tiers with the associated machines or components are to be monitored by machine learning.

As will also be described below, in various embodiments, the present invention is a computing module which integrated within an application discovery monitoring and optimization system. In various embodiments, the present application discovery and optimization invention, will itself identify application span across multiple diverse virtual machines and determines the associations of these application and clusters the application so that that the application being hosted by a common host are grouped together for easy access and identification after observing the activity by each of the machines or components for a period of time in the computing environment thereby enabling the machines to automatically learn where and how to access these applications and the iterations thereof.

Additionally, for purposes of brevity and clarity, the present application will refer to “machines or components” of a computing environment. It should be noted that for purposes of the present application, the terms “machines or components” is intended to encompass physical (e.g., hardware and software based) computing machines, physical components (such as, for example, physical modules or portions of physical computing machines) which comprise such physical computing machines, aggregations or combination of various physical computing machines, aggregations or combinations or various physical components and the like. Further, it should be noted that for purposes of the present application, the terms “machines or components” is also intended to encompass virtualized (e.g., virtual and software based) computing machines, virtual components (such as, for example, virtual modules or portions of virtual computing machines) which comprise such virtual computing machines, aggregations or combination of various virtual computing machines, aggregations or combinations or various virtual components and the like.

Additionally, for purposes of brevity and clarity, the present application will refer to machines or components of a computing environment. It should be noted that for purposes of the present application, the term “computing environment” is intended to encompass any computing environment (e.g., a plurality of coupled computing machines or components including, but not limited to, a networked plurality of computing devices, a neural network, a machine learning environment, and the like). Further, in the present application, the computing environment may be comprised of only physical computing machines, only virtualized computing machines, or, more likely, some combination of physical and virtualized computing machines.

Furthermore, again for purposes and brevity and clarity, the following description of the various embodiments of the present invention, will be described as integrated within a machine learning based applications discovery system. Importantly, although the description and examples herein refer to embodiments of the present invention integrated within a machine learning based applications discovery system with, for example, its corresponding set of functions, it should be understood that the embodiments of the present invention are well suited to not being integrated into a machine learning based applications discovery system and operating separately from a machine learning based applications discovery system. Specifically, embodiments of the present invention can be integrated into a system other than a machine learning based applications discovery system.

Embodiments of the present invention can operate as a stand-alone module without requiring integration into another system. In such an embodiment, results from the present invention regarding feature selection and/or the importance of various machines or components of a computing environment can then be provided as desired to a separate system or to an end user such as, for example, an IT administrator.

Importantly, the embodiments of the present machine learning based application discovery invention significantly extend what was previously possible with respect to providing applications monitoring tools for machines or components of a computing environment. Various embodiments of the present machine learning based application discovery invention enable the improved capabilities while reducing reliance upon, for example, an IT administrator, to manually monitor and register various machines or components of a computing environment for applications monitoring and tracking. This contrasts with conventional approaches for providing applications discovery tools to various machines or components of a computing environment which highly dependent upon the skill and knowledge of a system administrator. Thus, embodiments of present network topology optimization invention provide a methodology which extends well beyond what was previously known.

Also, although certain components are depicted in, for example, embodiments of the machine learning based applications discovery invention, it should be understood that, for purposes of clarity and brevity, each of the components may themselves be comprised of numerous modules or macros which are not shown.

Procedures of the present machine learning based automated application discovery using network flows information invention are performed in conjunction with various computer software and/or hardware components. It is appreciated that in some embodiments, the procedures may be performed in a different order than described above, and that some of the described procedures may not be performed, and/or that one or more additional procedures to those described may be performed. Further some procedures, in various embodiments, are carried out by one or more processors under the control of computer-readable and computer-executable instructions that are stored on non-transitory computer-readable storage media. It is further appreciated that one or more procedures of the present may be implemented in hardware, or a combination of hardware with firmware and/or software.

Hence, the embodiments of the present machine learning based applications discovery invention greatly extend beyond conventional methods for providing application discovery in machines or components of a computing environment. Moreover, embodiments of the present invention amount to significantly more than merely using a computer to provide conventional applications monitoring measures to machines or components of a computing environment. Instead, embodiments of the present invention specifically recite a novel process, necessarily rooted in computer technology, for improving network communication within a virtual computing environment.

Additionally, as will be described in detail below, embodiments of the present invention provide a machine learning based application discovery system including a novel search feature for machines or components (including, but not limited to, virtual machines) of the computing environment. The novel search feature of the present network optimization system enables ends users to readily assign the proper and scopes and services the machines or components of the computing environment, Moreover, the novel search feature of the present applications discovery system enables end users to identify various machines or components (including, but not limited to, virtual machines) similar to given and/or previously identified machines or components (including, but not limited to, virtual machines) when such machines or component satisfy a particular given criteria and are moved within the computing environment. Hence, as will be described in detail below, in embodiments of the present security system, the novel search feature functions by finding or identifying the “siblings” of various other machines or components (including, but not limited to, virtual machines) within the computing environment.

### Continued Detailed Description of Embodiments After Brief Overview

As stated above, feature selection which is also known as “variable selection”, “attribute selection” and the like, is an import process of machine learning. The process of feature selection helps to determine which features are most relevant or important to use to create a machine learning model (predictive model).

In embodiments of the present invention, a network topology optimization system such as, for example, provided in virtual machines from VMware, Inc. of Palo Alto, Calif. will utilize a network flow identification method to automatically identify application span across computing components and take remediation steps to improve discovery and access in the computing environment. That is, as will be described in detail below, in embodiments of the present network topology optimization invention, a computing module, such as, for example, the application discovery module 299 of FIG. 2, is coupled with a computing environment.

Additionally, it should be understood that in embodiments of the present machine learning based applications discovery module 299 of FIG. 2 may be integrated with one or more of the various components of FIG. 2. Application discovery module 299 then automatically evaluates the various machines or components of the computing environment to determine the importance of various features within the computing environment.

Additionally, in one embodiment, the network optimizer of the present invention, micro-segments the network domain to enhance network traffic

Several selection methodologies are currently utilized in the art of feature selection. The common selection algorithms include three classes: Filter Methods, Wrapper Methods and Embedded Methods. In Filter Methods, scores are assigned to each feature based on a statistical measurement. The features are then ranked by their scores and are either selected to be kept as relevant features or they are deemed to not be relevant features and are removed from or not included in dataset of those features defined as relevant features. One of the most popular algorithms of the Filter Methods classification is the Chi Squared Test. Algorithms in the Wrapper Methods classification consider the selection of a set of features as a search result from the best combinations. One such example from the Wrapper Methods classification is called the “recursive feature elimination” algorithm. Finally, algorithms in the Embedded Methods classification learn features while the machine learning model is being created, instead of prior to the building of the model. Examples of Embedded Method algorithms include the “LASSO” algorithm and the “Elastic Net” algorithm.

Embodiments of the present application discovery invention utilize a statistic model to determine the importance of a particular feature within, for example, a machine learning environment.

With reference now to FIG. 3, a block diagram of an exemplary virtual network system 300, in accordance with one embodiment of the present invention.

Cluster 310 utilizes a host group 310 with a first host 314A, a second host 314B and a third host 314C. Each host 314A-314C executes one or more VM nodes 312A-312F of a distributed computing environment. For example, in the embodiment in FIG. 3, first host 314A executes a first hypervisor 311A, a first VM node 312A and a second VM node 312B, Second host 314B executes a second hypervisor 311B and VM nodes 312C-312D and third host 314C executes hypervisor 311C and VM nodes 312E-312F. Although FIG. 3 depicts only three hosts in host group, it should be recognized that a host group in alternative embodiments may include any quantity of hosts executing any number of VM nodes and hypervisors. As previously discussed in the context of FIG. 3, VM nodes running in host may execute one or more distributed software components of the distributed computing environment.

VM nodes in hosts 310 communicate with each other via a network 330. For example, the NameNode the functionality of a master VM node may communicate with the Data Node functionality via network 330 to store, delete, and/or copy a data file using a server filesystem. As depicted in the embodiment in FIG. 3, cluster 300 also includes a management device 320 that is also networked with hosts 310 via network 330. Management device 320 executes a virtualization management application (e.g., VMware vCenter Server, etc.) and a cluster management application. Virtualization management application monitors and controls hypervisors executed by host 310, to instruct such hypervisors to initiate and/or to terminate execution of VMs such as VM nodes. In one embodiment, cluster management application communicates with virtualization management application in order to configure and manage VM nodes in hosts 310 for use by the distributed computing environment. It should be recognized that in alternative embodiments, virtualization management application and cluster management application may be implemented as one or more VMs running in a host in the IaaS or data center environment or may be a separate computing device.

As further depicted in FIG. 3, user of the distributed computing environment service may utilize a user interface on a remote client device to communicate with cluster management application in management device. For example, client device may communicate with management device using a wide area network (WAN), the internet, and/or any other network. In one embodiment, the user interface is a web page of a web application component of cluster management application that is rendered in a web browser running on a user's laptop. The user interface may enable a user to provide a cluster size data sets, data processing code and other preferences and configuration information to cluster management in order to launch cluster to perform a data processing job on the provided data sets. It should be recognized, in alternative embodiments, cluster management application may further provide an application programming interface (“API”) in addition supporting the user interface to enable users to programmatically launch or otherwise access clusters to process data sets. It should further be recognized that cluster management application may provide an interface for an administrator. For example, in one embodiment, an administrator may communicate with cluster management application through a client-side application, in order to configure and manage VM nodes in hosts 310 for example.

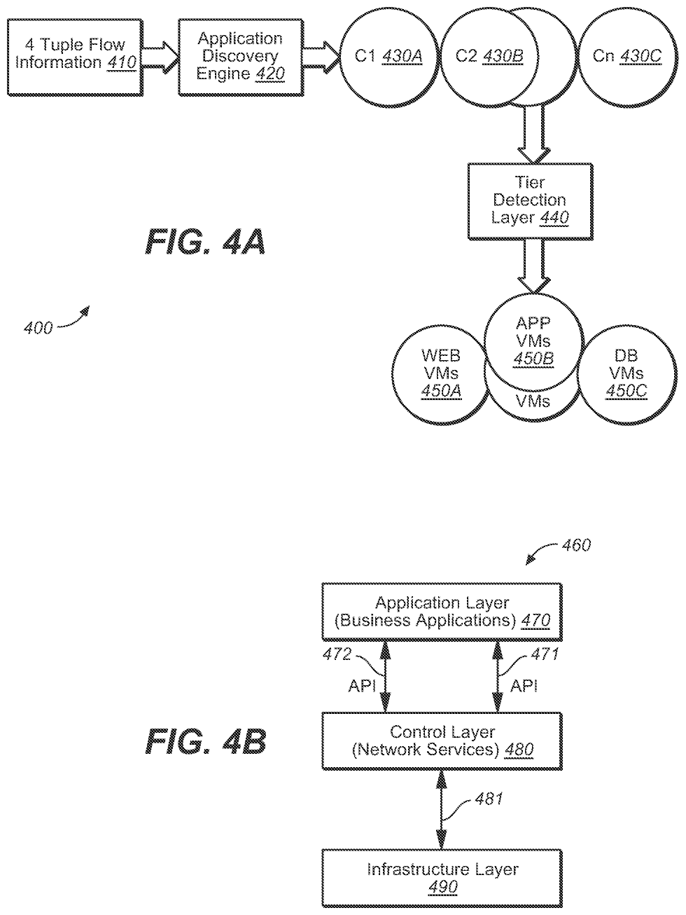

With reference now to FIG. 4A, a block diagram of an exemplary work-flow approach 400 of one embodiment of the machine learning based application discovery invention is shown. The present invention provides an agent-less, vendor agnostic and secure way to discover applications and tiers thereof in a computing environment automatically. The approach 400.depicted in FIG. 4 only requires a datacenter network flow information and their endpoints (i.e., VMs) in order to affect the machine learning principles of the invention.

Still referring to FIG. 4A, the netflow information is provided 410 to the application discovery engine 420 for processing. In one embodiment, the flow information is sourced from, for example, NetFlow, vDS IPFix and AWS flow logs. The application discovery engine 420 processes the input information to generate communication graphs of the various endpoints (C1 . . . Cn) 430. The communication graphs are then presented to the tier detection component 440 where the endpoint communication graph corresponding to a single application are segregated into multiple tiers based on the similarities in the pattern of the hosting and accessed points of the endpoints.

In one embodiment, the machine learning approach is based on the principles that the overlap in terms of communication profile for a pair of endpoints from the same application is greater than that for a pair of endpoints from different application. Also, the communication graph, the degree of connectivity within an application is significantly greater than the degrees of connectivity between two distinct applications. The similarity of the communication profile and degree of connectivity of endpoints can be exploited to perform the effective clustering of endpoints. Based on these principles the discovery engine 420 utilizes a vector encoding of an endpoint based on the communication patterns with the other endpoints. All endpoints are treated as individual dimensions. The component of the vector in the individual dimension is based on the communication pattern with the corresponding endpoint. In one embodiment, the endpoint could also be treated as a point in the multi-dimensional Euclidean space and coordinates of the point is derived from its vector encoding.

In one embodiment, a set of endpoints which belong to the same application would have the same coordinates values in most of the dimensions whereas the same would not be true for two endpoints of different application. This may be represented by the formula

√(x₁−y₁)²+(x₂−y₂)²+ . . . +(xₙ−yₙ)²

Based on the Euclidean distance metric, the endpoints corresponding to the same application would relatively be in close proximity to each other compared to endpoints of different applications implemented by the present invention. In one embodiment, the identified application endpoints can be coupled to an application by utilizing micro-segmentation rules to exclude other endpoints from the application.

In one embodiment of the invention, the application boundary endpoints locations (but not necessarily requiring knowledge of the corresponding application's location) are used to define a software defined network to enhance, for example, the security of the application or the computing network environment. As shown in FIG. 4B, the software-defined network comprises an applications layer 470, a control layer 480 and an infrastructure layer 490. The SDN 460 enables dynamic, programmatic efficient network configuration and management in order to improve network performance and monitoring making it more like a cloud computing than a traditional network management, SDN 460 is meant to address the fact that the static architecture of traditional networks is decentralized and complex while current networks require more flexibility and easy troubleshooting. SDN 460 attempts to centralize network intelligence in one network component by disassociating the forwarding process of network packets (data plane) from the routing process (control layer). The control layer consists of one or more controllers which are considered as the brain of SDN 460 network where the whole intelligence is incorporated.

In SDN 460, the network administrator can shape traffic from a centralized control console without having to touch individual switches in the network. The centralized SDN 460 controllers directs the switches to deliver network services wherever they are needed regardless of the specific connections between a server and devices. The SDN 460 architecture decouples the network control and forwarding functions enabling the network control to become directly programmable and the underlying infrastructure to be abstracted for applications and network services.

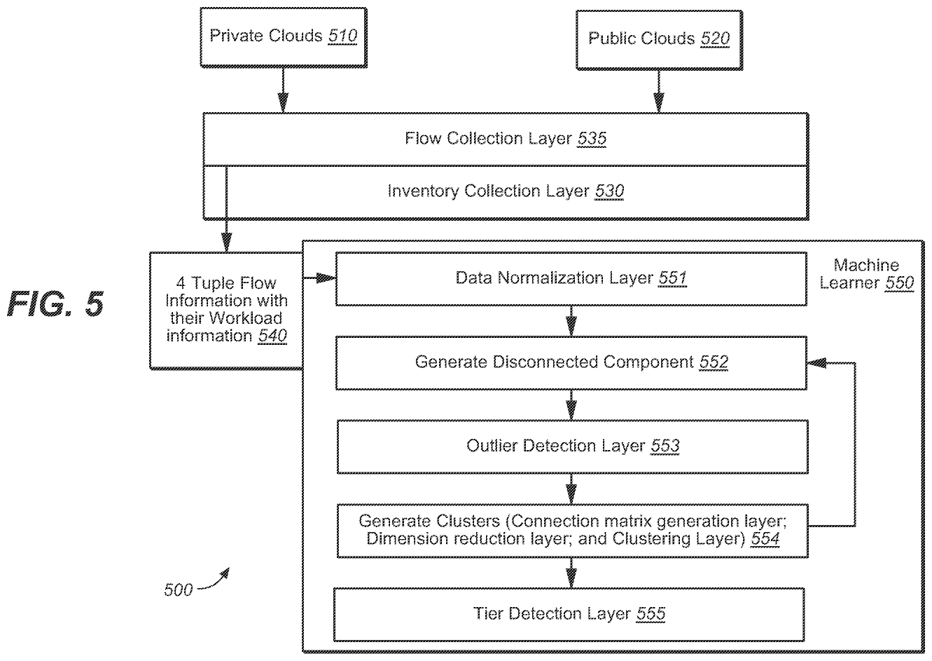

With reference now to FIG. 5, a block diagram of an exemplary components of one embodiment of the machine learning automated applications discovery 299 in accordance to an embodiment of the present invention is illustrated. As shown in FIG. 5, the computing environment 500 comprises a plurality of private cloud applications source 510, public cloud 520, flow collection component 535, inventory collection component 530, 4 Tuple flow information component 540 and machine learning based applications discovery component 550. As shown in FIG. 5, an embodiment of the present invention goes through multiple processing layers. Each layer has a critical functionality which can be independently implemented and optimized. As shown in FIG. 5, in one embodiment network flow data is generated from private cloud component 510 and together with public cloud flow data from public cloud component 520 and provided to flow collection layer. In one embodiment, the flow collection component 535 resides in the virtual realize network insight component (vRNI) in a host machine.

The flow layer 535 collects flows from the private cloud 510 and public cloud 520 using, for example, NetFlow and Flow Watcher logs respectively. The flow collection component 535 also collects VM inventory snapshots. With the help of inventory details, flow tuple information provided by 4 Tuple flow information component 540 is enriched with workload information. In one embodiment, the vRNI also enriches flows with traffic type information (e.g., for example East-West and North-South based on RFC 1918 Address Allocation for Private Internets).

Still referring to FIG. 5, machine learner 550 provides an automated machine learning based application discovery of applications and their related tiers across multiple and, sometimes, diverse computing components. In one embodiment, the machine learner 550 implements data normalization 551, generate disconnected component 552, outlier detection of components 553, generate clusters 554 and tier detection 555.

The data normalization layer 551 filters out the flow information provided by flow collection 535. In one embodiment, the filtering of the flow data is based on the exclusion of flow data corresponding to Internet traffic and the exclusion of flow data based on user feedback in terms of subnets and port ranges. The data normalizer 551 optimizes the accuracy and time-complexity of the overall discovery process. Data normalization is important as flow data corresponding to dynamic server port or SSH traffic are not important communications from the perspective of identifying application and tier boundaries. For the user-case of application discovery these communications can be seen as noise data as these don't reveal any useful information about the application topology in the datacenter.

Disconnected component layer 552 takes normalized flow data as input. A communication graph is built based on the input flow data. In this graph, nodes correspond to endpoints and the directed edges between nodes represent communication between endpoints. Each of the edges in the communication graph can output is annotated with port information as metadata. Construction of the communication graph can output one or more weakly connected components. Each Weakly connected component is considered separately because in general, it would be the case that an application spans across multiple weakly connected components

Still referring to FIG. 5, outlier detection layer 523 detects outlier in the input graph. The outlier detection layer 553 helps determine whether the input communication graph requires further refinement based on the presence of common services. Node representing common services would generally have high in-degree or out-degree in the endpoint communication graph. In one embodiment to detect outlier nodes, a table is created that contains in-degree and out-degree of each node and perform a univariate analysis on in-degree and out-degree of nodes to find outliers using, for example, the MAD algorithm.

The clustering layer 554 takes endpoint communication graph as input and generates clusters of endpoints. An output cluster would contain the endpoints of similar communication patterns. In one embodiment, the cluster layer 554 includes a connection matrix generation component, a dimension reduction component and a clustering component. The clustering layer 554 comprise the step of vectorization of endpoints, dimensionality reduction and clusters. In vectoring the endpoints, the adjacency matrix of the endpoint communication graph is created. For N endpoints a N*N adjacency matrix is created. Each row of the matrix corresponding to an endpoint can be seen as the vector representation of that endpoint in N dimension.

In reducing the dimensionality of the endpoints, for large number of endpoints (e.g., N endpoints) a clustering algorithm cannot be performed directly on the N-dimensional representation of endpoints obtained from the vectorization process. So, a PCA based on singular value decomposition to reduce the number of dimensions is used. To choose the optimal number of dimensions the cumulative explained variance ratio is used as a function of the number of dimensions, the optimal number of dimensions should retain 90% of the variance. Using PCA a representation of endpoints in lower dimensional space such that the variance in the reduced dimensional space is maximized.

After the dimensionality reduction, clustering of the datapoints is performed. In one embodiment, two different clustering algorithms may be used. In a first instance, k-means++ algorithm is used to run cluster with random values of initial cluster centers. A Sum of square distances analysis is used to optimize the final set of clusters and the number of iterations to get the final cluster. Even though the running time of k-means++ is better than other clustering algorithms but is does not show good results with noisy data or outliers.

Still with reference to FIG. 5, the tier detection layer 555 takes the endpoints communication graph corresponding to a single application as input and then segregates the endpoints within the application into multiple tiers. In this case, the grouping criterion based on similarities in the pattern of hosted and accessed ports, are considered to be part of the same tier, i.e., vectorization of endpoints works a bit differently.

In one embodiment, all parts of an application are retrieved and two tags for each port is created (e.g., for port 442 two tags are created—Hosted 443, Accessed:443). A matrix with the tags created are matrixed as columns. Each row of the matrix would correspond to an endpoint. If an endpoint is hosting port 443 then the corresponding cell (Hosted:443) in the matrix is marked as 1 (otherwise 0), similarly, if an endpoint is accessing port 443 then the corresponding cell (Accessed: 443) is marked as 1 (otherwise 0). The columns of the above connection matrix represent the multiple dimensions of the endpoint vector. After that, the dimension reduction algorithm and clustering algorithms are applied to group endpoints within an application across multiple tiers.

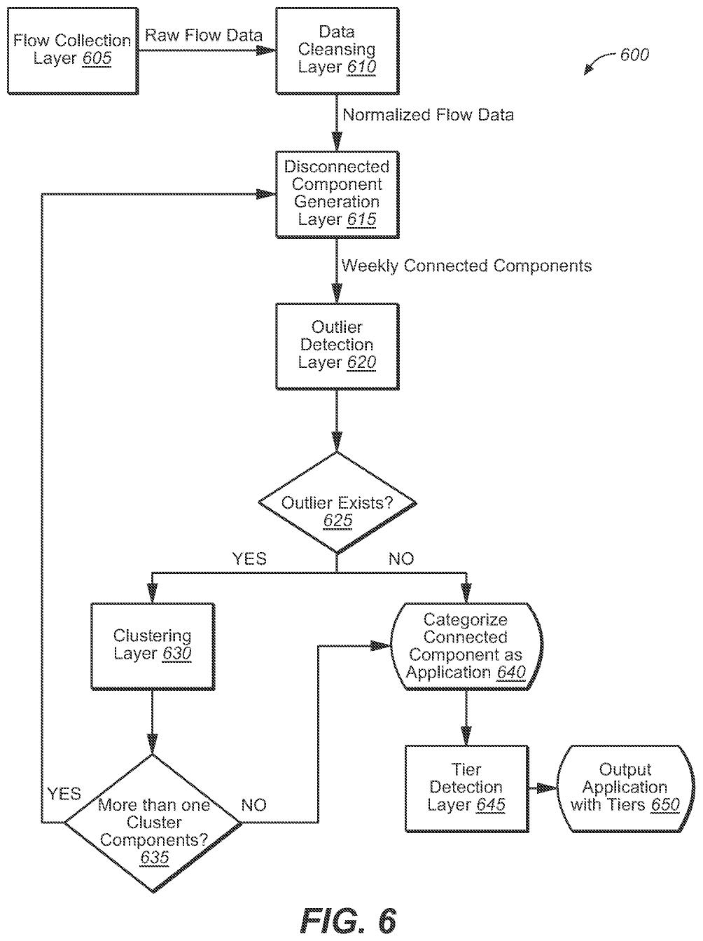

Referring now to FIG. 6, a flow chart of an applications detection workflow process in accordance to one embodiment of the present invention is depicted. As shown at Step 610 the automated application discovery process starts with the collection of enriched flow data from vRNI and forwards the data to data cleansing step 610. At Step 610, the flow data is filtered and then passed on to the disconnected component generation step 615.

At the disconnected component generation step 615, a network communication graph is created based on the input flow data and then produces multiple weakly connected components as output. In one embodiment, for each weakly connected component, an outlier detection is invoked. At outlier detection step 620, a check of the existence is made at Step 625. If any outliers are detected, processing continues at step 630 where the data flow presented to the outlier is forwarded to clustering layer and processing continues at step 630. If on the other hand, no outliers are detected, processing continues at step 640 where the data flow presented to the outlier at step 630 is classified as an application.

At Step 630, if the cluster layer finds more than one cluster in the input connected component a determination is made at step 635 if more than one cluster component is present. If more than one cluster component is present, the information is forwarded to the disconnected component generation at step 615 for processing. If on the other hand, a single cluster component is detected at step 635, the information is forwarded to step 640 where the connected component information is categorized as an application.

At Step 645 the application component from step 640 is processed to be associated with its corresponding tiers.

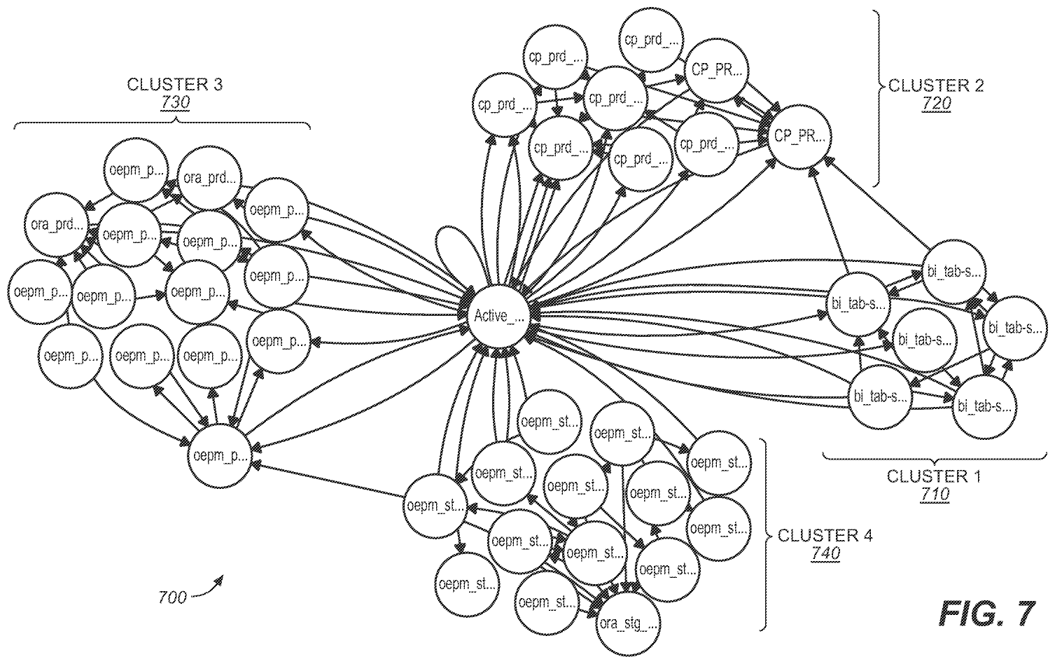

FIG. 7 is an exemplary topology diagram showing an exemplary communication pattern of a selected set of applications in an exemplary IT computing environment. The computer environment topology depicted in FIG. 7 is based on an exemplary environment in the VMware Software Defined Data Center (SDDC) computing environment. As shown in FIG. 7, the auto-discovery invention 299 identifies 5 separate clusters—Cluster 1-Cluster5. Cluster 1 corresponds to Ocpm Staging, Cluster 2 corresponds to Oepm Prod, Cluster3 correspond to BI Tab, Cluster4 corresponds to CP Prod and Cluster5 corresponds to Active Directory application groups. Only one VM of Active Directory (Cluster5) is shown to keep the virtualization simple.

Based on the application defined by the applications administrator in the computing environment (e.g., VMware's SDDC computing platform), Oepm Staging and Oepm Prod groups should have been part of the same application. However, based on the observed communication patterns, we can see that there are too many communication links within each of these groups but hardly see any communication going across these groups. Hence the present auto-detect component detects Oepm Staging and Oepm Prod groups as two separate applications based on the communication patterns.

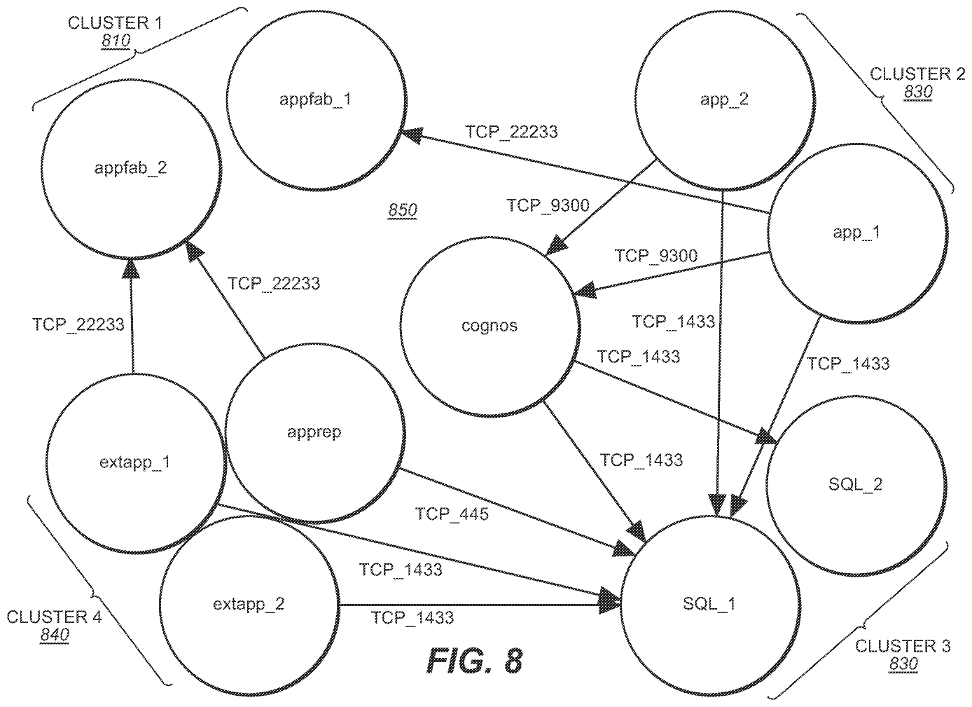

Referring now to FIG. 8, an exemplary applications topology of the application of one embodiment of the auto-detect method in accordance to one embodiment of the present invention is shown. The environment 800 shown in FIG. 8 depicts the detection and segregation of endpoints in a computing environment. As shown although the endpoints span across multiple tiers for an identified application (e.g., ChangePoint) in the SDDC environment, the endpoints of each tier have the same hosted ports or accessed ports, for example, SQL-1 and SQL-2 are part of the same tier as they are hosting TCP connection on port 1433. Hence the endpoints are segregated and clustered for automatic discovery.

As will be described below in detail, various embodiments of the present invention also automatically provide and assign appropriate and meaningful names to automatically discovered Applications and Tiers within a virtual infrastructure (VI). In embodiments of the present invention, the automatically provided/assigned names are meaningful to enable a VI and network administrator to refer these Applications and Tiers having the automatically assigned names, for example but not limited to, security and planning, migration, troubleshooting, day-2 operations and disaster recovery use cases. In various embodiments, the assigned names also represent the business goal(s) of the Applications and Tiers.

For the purpose of describing embodiments of the present invention, consider the following example. A virtual infrastructure (VI) customer, for example, but not limited to, a datacenter client, wants a product to automate network troubleshooting workflow starting from a support ticket itself which only has business details. For example, the VI customer's support ticket only states “a VI portal is responding very slowly”, or “VI portal is down”. In embodiments of the present invention, the VI product will automatically point to the exact discovered application and automate a network troubleshooting workflow based merely on the application name or other details provided in the customer's support ticket. Hence, as will be described below in detail, in embodiments of the present invention, because the discovered application has been provided/assigned a meaningful business name/label, the troubleshooting of various application support tickets can be made completely automated. In various embodiments of the present invention, a customer's support ticket is received and embodiments of the present invention will understand the underlying business meaning and map the appropriate Application to the customer's support ticket and automatically execute an appropriate application troubleshooting workflow. Thus, embodiments of the present invention utilize machine learning/text mining and statistical approaches to obtain the above-described objectives and advantages.

As mentioned above, embodiments of the present invention automatically provide and assign names to Applications and Tiers using various properties of the constituent members of the Applications and Tiers and automatically select a relevant property for the naming thereof. Embodiments of the present invention use various text mining approaches to identify the best property which can then be used to name the Application and Tier. Furthermore, embodiments of the present invention, to assign a meaningful name, identify words in the properties which represent the Applications and Tiers uniquely to ensure that the assigned name is appropriate for the Applications and Tiers.

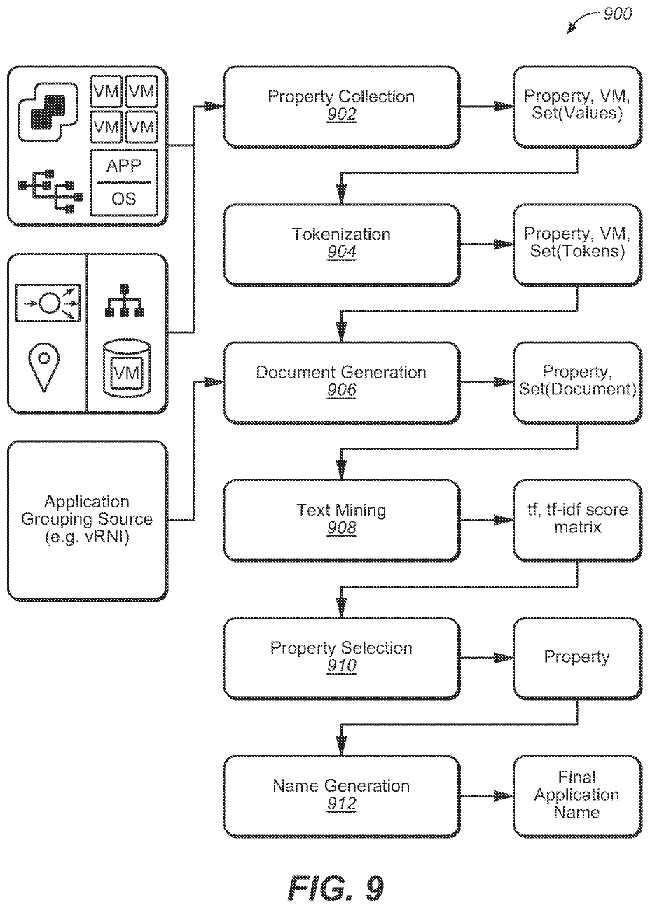

With reference now to FIG. 9, a workflow diagram 900 of actions performed to assign meaningful business names to auto discovered Applications and Tiers, in accordance with an embodiment of the present invention, is shown. As shown in FIG. 9, embodiments of the present invention includes layers of actions including, for example, Property collection layer 902, Tokenization layer 904, Document generation layer 906, Text mining layer 908, Property selection layer 910 and Name generation layer 912.

At 902 of FIG. 9, property collection is performed. The properties of the members under consideration are primarily of 3 types. The three types are namely: Direct properties; Indirect properties, and Properties derived from a third-party or user input. In embodiments of the present invention, Direct properties of the members are inherent to member objects or a data model. Examples of Direct properties are names, tags, etc. assigned to members of a virtual environment, security tags, and the like.

With reference still to 902 of FIG. 9, in embodiments of the present invention, Indirect properties of the members are properties which come from the association of the member object with other objects. These Indirect properties include, but are not limited to Security Groups, Load balancer VIP, geo-location, availability zones, host, datacenter, VPC, VLAN, folder etc. Various embodiments of the present invention may use fewer than all of the above-listed Indirect properties in the present assignment of meaningful business names for auto discovered Applications and Tiers.

Referring still to 902 of FIG. 9, in embodiments of the present invention, Third party properties are the properties which are assigned by the user for manual/automated workflows in IT Service Management (ITSM), and IT Operations Management (ITOM) products. In embodiments of the present invention, typically these properties are used by a customer to logically group the members for various custom use cases. These properties are stored in a configuration management database (CMDB) or other modes such as, but not limited to, a comma separated values (csv) file and databases.

With reference next to 904 of FIG. 9, embodiments of the present invention perform a tokenization operation. Tokenization is a process where an input text or string is broken into smaller words. In embodiments of the present invention, the tokenization operation or process is performed using text mining techniques to extract richer information from constituent words than can be extracted from the text itself. Various embodiments of the present invention extract tokens using commonly used separators such as, but not limited to, ‘_’, ‘-’, ‘.’, ‘/’, ‘:’, ‘;’ and the like. Embodiments of the present invention, also extract token information (i.e., information extracted during the tokenization operation) using regular expression (regex) patterns. Additionally, in various embodiments of the present invention, the tokenizer (i.e., the module(s) performing the tokenization operation) also employ a method which uses combinations of separators and patterns.

With reference still to 904 of FIG. 9, embodiments of the present invention utilize the present tokenization layer 904 to extract more information from a document than is provided by the words themselves. As an example, in most datacenters, admins use various naming conventions. Hence, a property of a data-center object is that the datacenter object may contain various constituent words other than the property value itself. As an example, a Virtual Machine (VM) name such as vrni-dev-web-vml may be assigned to a datacenter object. In embodiments of the present invention, when such a name is tokenized, various interesting tokens are obtained which represent important information such as, for example, but not limited to, the org-deployment type-tier-vm name. Hence, in embodiments of the present invention, tokenization layer 904 represents a valuable operation providing beneficial text mining information.

With reference next to 906 of FIG. 9, embodiments of the present invention include document generation layer 906 for performing a document generation operation. In embodiments of the present invention, during the document generation operation, groups of tokens are collected from a sole source of data like string or text which is referred to as a document. The groups of tokens called documents are then stored for further use. Embodiments of the present invention, collect all the tokens from a specific property for an Application/Tier and store the tokens as a document. Hence, in embodiments of the present invention, a document is created for each property for each Application/Tier.

With reference next to 908 of FIG. 9, embodiments of the present invention include text mining layer 908 for performing a text mining operation. In embodiments of the present invention, text mining layer 908 performs functions including the generation of a Term Frequency (TF) Matrix, generating Document Frequency information, obtaining an Inverse Document Frequency (IDF), and generating TF-IDF Matrix of a document. Each of these functions of the various embodiments of the present invention are explained below.

Referring still to 908 of FIG. 9, in various embodiments of the present invention the Term Frequency (TF) Matrix function is performed as follows. The number of times a term occurs in a document is referred to as its term frequency. In various embodiments of the present invention, statistically, the weight of a term that occurs in a document is proportional to the term frequency. Conventional approaches use TF data to remove the most frequent terms as the weight of the corresponding tokens is less. Unlike conventional approaches, various embodiments of the present invention utilize the highest TF tokens as part of the name of the Application.

With reference again to 908 of FIG. 9, in datacenters, admins use hierarchical naming schemes where the VM properties can have many repeating tokens across the Application and Tiers. In various embodiments of the present invention, such repeated tokens provide very important data such as, but not limited to, location, datacenter, cluster or parent business Application name. Hence, various embodiments of the present invention utilize the generated TF Matrix to obtain the prefix portion of the Application/Tier.

Referring still to 908 of FIG. 9, in various embodiments of the present invention, the TF is computed using the below formula:

tf(t,d)=count of t in d/number of words in d
Where d is document corpus. For our implementation d contains tokens from all the VMs properties of an application.

With reference again to 908 of FIG. 9, in various embodiments of the present invention, Document Frequency (DF) is utilized to measure the importance of a document in a whole set of corpora (i.e., the plural of corpus). In various embodiments of the present invention DF is very similar to TF, but TF represents a frequency counter for a term tin document d, whereas DF is the count of occurrences of term t in the document set N. Hence, in various embodiments of the present invention, DF is the number of documents in which the term t is present. Various embodiments of the present invention consider an occurrence of the term t to have occurred if the term t exists in a document at least once. That is, in various embodiments of the present invention, the DF determination performed at 908 of FIG. 9 is not required to calculate or determine the exact number of times that the term t is present in each document comprising document set N.

Referring still to 908 of FIG. 9, in various embodiments of the present invention, the TF is computed using the below formula and using the expression df(t) to represent DF of a term t:

df(t)=occurrence of t in documents

Referring once more to 908 of FIG. 9, in various embodiments of the present invention, the IDF is computed for the following reasons. As stated above, in various embodiments of the present invention, when computing TF, all terms are considered equally important. However, various embodiments of the present invention are aware that certain terms, such as, for example, but not limited to, “is”, “of”, and “that”, may appear in a document numerous times, but such terms often have little importance. Thus, various embodiments of the present invention reduce the weight/value of such frequent terms while increasing the weight of rare (or less frequently occurring) terms, by computing the IDF. In various embodiments of the present invention an inverse document frequency factor is utilized to diminish/reduce the weight of terms that occur very frequently in the document set. Conversely, various embodiments of the present invention increase the weight of terms that occur rarely (less frequently).

Referring still to 908 of FIG. 9, in various embodiments of the present invention, the IDF is computed using the below formula and using the expression idf(t) to represent the IDF of a term t:

idf(t)=N/df(t)

With reference again to 908 of FIG. 9, various embodiments of the present invention explicitly address certain issues with the IDF computation. Specifically, various embodiments of the present invention acknowledge that in case of a large corpus, such as, for example, a corpus 100,000,000, the IDF value can become extremely large. To avoid such an effect, various embodiments of the present invention utilize the log of the IDF value. Furthermore, in various embodiments of the present invention, it is understood that during the query time, when a word/term does not occur or is not in the vocabulary, the DF, or df(t) will have a value of 0. As it is not feasible to utilize a value of 0 as a divisor, various embodiments of the present invention, explicitly account for such a possibility by adding the value 1 to the denominator in the formula used to calculate the IDF.

Referring still to 908 of FIG. 9, hence, in various embodiments of the present invention, the IDF is ultimately computed using the below final formula and using the expression idf(t) to represent the IDF of a term t:

idf(t)=log(N/(df(t)+1))

Referring once again to 908 of FIG. 9, in various embodiments of the present invention, TF-IDF is utilized to evaluate the importance of a word/term to a document in a collection or corpus. In various embodiments of the present invention, TF-IDF is computed using the below formula and using the expression tf−idf(t, d) to represent the TF-IDF of a term t to a document in a collection or corpus (it should be understood, however, that the present invention is also well suited to using any of numerous other variations for calculating TF-IDF)

tf−idf(t, d)=tf(t, d)*log(N/(df(t)+1))

Various embodiments of the present invention, then utilize the TF-IDF score to fetch the most relevant tokens from the documents of the Applications. In various embodiments of the present invention, the tokens with highest TF-IDF value are then used in the suffix portion of the Application/Tier name as such tokens and the corresponding suffix uniquely represent the Application/Tier.

With reference next to 910 of FIG. 9, embodiments of the present invention include property layer 910 for selecting the most useful property of the VM for naming an Application/Tier. Embodiments of the present invention fetch all the specified the properties of the VM. Additionally, embodiments of the present invention explicitly address situations in which all of the properties are not available for all the VMs of the Applications/Tiers. That is, various embodiments of the present invention determine the best property for naming in the following manner.
1. Utilize the text-mining layer and compute the TF-IDF score of all of the tokens for all of the properties of all Applications and Tiers.
2. Sort the documents containing TF-IDF score in descending order.
3. Compute mean and standard deviation of top 5 TF-IDF score for each document for all the properties.
4. Select the property having both highest mean values. In case of two properties are having same mean, select the property with lowest standard deviation.
5. Mean is computed using the formula a. Mean (μ)=(tf−idf1+tf_idf2 . . . tf−idf5)/5
6. Standard deviation is calculated using the formula a. Standard deviation=Sqrt((|x−μ|\hat{ }2)/5)
7. The reason for utilizing mean is to select the property which can provide more unique tokens to name the Application.

With reference next to 912 of FIG. 9, embodiments of the present invention include name generation layer 912 for automatically generating the name for an Application/Tier from the documents. More specifically, in embodiments of the present invention, name generation layer 912 extracts a fixed number of tokens to automatically generate a name for an Application/Tier from the examined documents. In various embodiments of the present invention, the automatically generated name is divided into two parts, the prefix and the suffix. Conventionally, enterprise naming schemes follow the hierarchical model where the naming starts from the organization (org) name, followed by the business function, and then followed by the specific entity name. Unlike such conventional schemes, embodiments of the present invention automatically generate and provide a name for an Application/Tier wherein the name is easier to understand and provides more information about the entity in a more compact naming structure.

As described above, in various embodiments of the present invention, the prefix portion of the automatically generated name is assigned using the tokens with highest TF score. Further, in various embodiments of the present invention, the tokens with highest TF score usually represent the common part of the names of the hierarchical naming scheme such as, but not limited to, org name, BU (Business Unit) name, location, and the like. Further, in various embodiments of the present invention, the suffix portion of the name represents the tokens which correspond to the Application and Tier uniquely. Hence, in various embodiments of the present invention, tokens with highest TF-IDF score are used to automatically assign the suffix portion of the name.

### Example Operation

An example operation of an embodiment of the present invention is provided below. Fetch a set of property of the all the VMs in the applications and tiers. The properties can be modified as per customer requirement. The fetched properties should be stored in local store for further use.

| | | | | | Security | Security | | | | Tag |
|---|---|---|---|---|---|---|---|---|---|---|
| Name | Datacenter | Cluster | IPSet | Folder | Tag | Group | Host | [symbol] | Hostname | Key |
| staging- | controller- | controller- | [symbol] | staging-jira- [symbol] - | [symbol] | [symbol] | controller- [symbol] | controller- [symbol] | staging- [symbol] -STD- | [symbol] |
| jira-STD- | [symbol] -dc [symbol] | [symbol] | | STD | | | [symbol] .example.com | [symbol] .example.com | 10.example.com | |
| 10 | | | | | | | | | | |
| controllwe- | controller- | controller- | [symbol] | [symbol] | [symbol] | [symbol] | controller- [symbol] | controller [symbol] | controller [symbol] | [symbol] |
| vpl- [symbol] -005 | [symbol] | [symbol] | | clients | | | [symbol] .example.com | [symbol] .example.com | 005.example.com | |
| staging- | staging05- | staging05- | [symbol] | staging-jira [symbol] | [symbol] | [symbol] | staging05- [symbol] | staging05- [symbol] | staging- [symbol] | Owner |
| jira- [symbol] | [symbol] | [symbol] | | | | | [symbol] .example.com | [symbol] .example.com | 004 | (OS |
| 004 | | | | | | | | | | Layer) |
| staging- | controller- | controller- | [symbol] | staging- [symbol] | [symbol] | [symbol] | [symbol] | [symbol] | staging [symbol] | [symbol] |
| jira- | [symbol] | [symbol] | | [symbol] | | | [symbol] .example.com | [symbol] example.com | portal- | |
| portal-01 | | | | [symbol] -portal1 | | | | | 01.example.com | |
| VDM | staging05- | staging0 [symbol] - | [symbol] | Templates | [symbol] | [symbol] | staging05-jira- | staging05-jira- | [symbol] | [symbol] |
| | jira- [symbol] | [symbol] | | | | | [symbol] .example.com | [symbol] .example.com | | |

[symbol]

indicates data missing or illegible when filed

For each property type tokenize the property value of the VMs/members under consideration. Store the tokenized data in as lists. These lists are called documents. Hence, various embodiments of the present invention will have a document for each property type for each Application/Tier. The present example considers, two properties name, security groups. In the example table we have 3 applications where app1, app2 and app3.

Various embodiments of the present invention tokenize the VM name and security groups as mentioned below.

vmware-jira-prod-web-vm1 tokenized to {vmware, jira, prod, vm}

Various embodiments of the present invention remove the number from the tokens. Each group's token is called a document (d). For app1 various embodiments of the present invention will obtain two documents as shown below.
Name property document:
{vmware, jira, prod, vm, vmware, jira, prod, app, vm, vmware, jira, prod, db, vm}
Security Group Property Document:
{sg, vmware, jira, prod, vm, vmware, jira, prod, app, vm, vmware, jira, prod, db, vm}
After all the documents are crated, we call the text mining layer and generate the TF and TF-IDF matrix for each document we generated in the previous step.
Sample tokens along with TF-IDF values along with mean and standard deviation values:

-------------------IPSet--------------------
tokens: [‘internal’, ‘ipset’, ‘network’, ‘servers', ‘vmware’]
internal 0.0
ipset 0.0
network 0.0
servers 0.0
vmware 0.0
Name: 23, dtype: float64
count 5.0
mean 0.0
std 0.0
min 0.0
25% 0.0
50% 0.0
75% 0.0
max 0.0
Name: 23, dtype: float64
None
---------------------------------------------

-------------------Folder--------------------
tokens: [‘4x’, ‘blr’, ‘clients', ‘cloneprepreplicavmfolder’, ‘corpit’, ‘dempoc’, ‘discovered’, ‘edge’, ‘eng’,
‘fc’, ‘fcd’, ‘fd’, ‘gen’, ‘gm’, ‘hvm’, ‘ic’, ‘icd’, ‘icf’, ‘instant’, ‘m’, ‘machine’, ‘management’, ‘mgmt’, ‘new’,
‘nsx’, ‘od’, ‘parent’, ‘production’, ‘rds', ‘rpa’, ‘sc’, ‘sjc’, ‘std’, ‘template’, ‘templates', ‘test’, ‘uat’, ‘ubu’,
‘vcf’, ‘viewplanner’, ‘virtual’, ‘vm’, ‘vms', ‘w’, ‘wdc’]
sjc 0.553140
uat 0.505881
ic 0.336694
viewplanner 0.296402
clients 0.269456
rds 0.216446
rpa 0.188619
ubu 0.144297
vcf 0.120248
icf 0.120248
Name: 23, dtype: float64
count 10.000000
mean 0.275143
std 0.153055
min 0.120248
25% 0.155378
50% 0.242951
75% 0.326621
max 0.553140
Name: 23, dtype: float64
sjc-ic-uat
---------------------------------------------

-------------------Security Tag--------------------
tokens: [‘mcafee’, ‘move’, ‘unprotected’, ‘yes']
mcafee 0.0
move 0.0
unprotected 0.0
yes 0.0
Name: 23, dtype: float64
count 4.0
mean 0.0
std 0.0
min 0.0
25% 0.0
50% 0.0
75% 0.0
max 0.0
Name: 23, dtype: float64
None
---------------------------------------------

-------------------Security Group--------------------
tokens: [‘all’, ‘clus', ‘cp’, ‘dlb’, ‘dp’, ‘dyn’, ‘external’, ‘harbor’, ‘ingress', ‘move’, ‘nlb’, ‘od’, ‘ondesk’,
‘poollb’, ‘registry’, ‘sg’, ‘src’, ‘system’, ‘vdi’, ‘vmware’, ‘whitelist’]
all 0.0
od 0.0
vmware 0.0
vdi 0.0
system 0.0
src 0.0
sg 0.0
registry 0.0
poollb 0.0
ondesk 0.0
Name: 23, dtype: float64
count 10.0
mean 0.0
std 0.0
min 0.0
25% 0.0
50% 0.0
75% 0.0
max 0.0
Name: 23, dtype: float64
None
---------------------------------------------

-------------------Hostname--------------------
tokens: [‘1a’, ‘2a’, ‘4a’, ‘4x’, ‘5a’, ‘a’, ‘admin’, ‘aem’, ‘ag’, ‘agnt’, ‘alm’, ‘apex’, ‘app’, ‘auth’, ‘auth1a’,
‘av’, ‘avfsl’, ‘avol’, ‘base’, ‘bi’, ‘bip’, ‘blr’, ‘boomi’, ‘c’, ‘cache’, ‘cbr’, ‘cbrpm’, ‘cc’, ‘ccm’, ‘cdb’, ‘cdf’, ‘cf’,
‘cfg’, ‘cilt’, ‘cl’, ‘cm’, ‘com’, ‘con’, ‘controller’, ‘core’, ‘cs', ‘ctm’, ‘ctrl’, ‘cust’, ‘d’, ‘db’, ‘dbmaster’,
‘dbslave’, ‘dc’, ‘ddns', ‘dem’, ‘dempoc’, ‘dev’, ‘disp’, ‘dlr’, ‘doc’, ‘dp’, ‘dr’, ‘drm’, ‘drupal’, ‘dynatrace’,
‘ebs', ‘ebssso’, ‘edg’, ‘elk’, ‘en’, ‘eng’, ‘entl’, ‘eoo’, ‘epms', ‘es', ‘esc’, ‘etl’, ‘f’, ‘fcd’, ‘flx’, ‘fnd’, ‘g’, ‘gen’,
‘gfr’, ‘gt’, ‘hfm’, ‘hn’, ‘hppe’, ‘hz’, ‘iam’, ‘ic’, ‘icf’, ‘idm’, ‘idmws', ‘inc’, ‘inf’, ‘infra’, ‘int’, ‘inta’, ‘ithppc’,
‘jmp’, ‘jscape’, ‘kafka’, ‘kube’, ‘logstash’, ‘lrp’, ‘lstnr’, ‘lt’, ‘lw’, ‘m’, ‘maria’, ‘md’, ‘mgo’, ‘mgr’, ‘ml’, ‘mln’,
‘mon’, ‘ms', ‘msvcs', ‘mt’, ‘mtvrops', ‘mysql’, ‘nfs', ‘nprd’, ‘nprod’, ‘nsx’, ‘nsx01a’, ‘nsx01b’, ‘nsx01c’,
‘nsxt’, ‘nutch’, ‘nw’, ‘oam’, ‘oauth’, ‘od’, ‘odm’, ‘odn’, ‘oel’, ‘oepm’, ‘old’, ‘onedesk’, ‘ora’, ‘oraosb’,
‘orasoa’, ‘os', ‘patch’, ‘pc’, ‘pd’, ‘pdh’, ‘pds', ‘pl’, ‘plg’, ‘poc’, ‘portal’, ‘prtlo’, ‘psy’, ‘pub1a’, ‘pub2a’,
‘pub3a’, ‘pub4a’, ‘r’, ‘rac’, ‘rc’, ‘rcvry’, ‘rds', ‘redis', ‘repo’, ‘rev’, ‘rm’, ‘rpa’, ‘rtr’, ‘s', ‘sc’, ‘script’, ‘sfa’,
‘sftp’, ‘sjc’, ‘sjcuat’, ‘soa’, ‘sql’, ‘srdb’, ‘srv’, ‘sso’, ‘std’, ‘stg’, ‘sup’, ‘tab’, ‘tabl’, ‘test’, ‘tsm’, ‘tst’, ‘uat’,
‘ubu’, ‘umaster’, ‘uworker’, ‘vc’, ‘vcf’, ‘vdimon’, ‘vhelp’, ‘visl’, ‘vmtst’, ‘vmw’, ‘vmware’, ‘vmwtest’,
‘vmwtestdc’, ‘vp’, ‘vpl’, ‘w’, ‘wcp’, ‘wdc’, ‘web’, ‘webapp’, ‘wg’, ‘win’, ‘wk’, ‘wsvcs', ‘wwwa’,
‘wwwapps']
sjc 0.438868
uat 0.400706
vmware 0.319192
com 0.309073
vpl 0.301663
cl 0.301663
sc 0.296165
rpa 0.211164
ubu 0.161545
sjcuat 0.150831
Name: 23, dtype: float64
count 10.000000
mean 0.289087
std 0.093106
min 0.150831
25% 0.232414
50% 0.301663
75% 0.316663
max 0.438868
Name: 23, dtype: float64
sjc-vmware-com
---------------------------------------------

-------------------Tag Key--------------------
tokens: [‘application’, ‘creation’, ‘date’, ‘decomannotation’, ‘email’, ‘group’, ‘layer’, ‘name’, ‘os',
‘owner’, ‘project’, ‘ticket’]
layer 0.607110
os 0.607110
owner 0.512675
application 0.000000
creation 0.000000
date 0.000000
decomannotation 0.000000
email 0.000000
group 0.000000
name 0.000000
Name: 23, dtype: float64
count 10.000000
mean 0.172689
std 0.279242
min 0.000000
25% 0.000000
50% 0.000000
75% 0.384506
max 0.607110
Name: 23, dtype: float64
owner-os-layer1
---------------------------------------------

-------------------Tag--------------------
tokens: [‘ownerXYZ’, ‘as', ‘cdf’, ‘cms', ‘com’, ‘corp’, ‘dba’, ‘dcmetro’, ‘dev’, ‘devportal’, ‘grant’, ‘iam’,
‘idm’, ‘it’, ‘jan’, ‘linux’, ‘mgr’, ‘net’, ‘nov’, ‘off’, ‘oracle’, ‘per’, ‘poc’, ‘powered’, ‘project’, ‘ABC’,
‘ownerABC’, ‘ownerPQR’, ‘ownerPQRm’, ‘rfctesting’, ‘sa’, ‘task’, ‘team’, ‘upgade’, ‘upgrade’, ‘view’,
‘vmware’, ‘webserver’, ‘windows']
team 0.520427
corp 0.520427
view 0.520427
com 0.306160
vmware 0.306160
ownerXYZ 0.000000
project 0.000000
ABC 0.000000
ownerABC 0.000000
ownerPQR 0.000000
Name: 23, dtype: float64
count 10.000000
mean 0.217360
std 0.242108
min 0.000000
25% 0.000000
50% 0.153080
75% 0.466860
max 0.520427
Name: 23, dtype: float64
corp-view-team6
---------------------------------------------

After step 3 embodiments of the present invention call the Property selection layer. For each Application/Tier, this layer selects the property to be used for naming of the application tier.

| Property Name | Mean | Standard deviation | Comment |
|---|---|---|---|
| IPSet | 0 | 0 | Ignored because |
| | | | there is no |
| | | | standard deviation |
| | | | and mean value |
| Folder | .27 | .15 | |
| Security Tag | 0 | 0 | Ignored because |
| | | | there is no |
| | | | standard deviation |
| | | | and mean value |
| Security Group | 0 | 0 | Ignored because |
| | | | there is no |
| | | | standard deviation |
| | | | and mean value |
| Hostname | .28 | .09 | |
| Tag Key | .17 | .27 | |
| Tag | .21 | .24 | |

| Property Name | Mean | Standard deviation | Suggested Name |
|---|---|---|---|
| Folder | .27 | .15 | sjc-ic-uat |
| Hostname | .28 | .09 | sjc-vmware-com |
| Tag Key | .17 | .27 | owner-os-layer |
| Tag | .21 | .24 | corp-view-team |

| Property Name | Mean | Standard deviation | Suggested Name |
|---|---|---|---|
| Folder | .11 | .33 | vm9 |
| Hostname | .27 | .16 | portal-lt-com-vmware |
| Tag Key | 0 | 0 | NA |
| Tag | 0 | 0 | NA |
| Name | .23 | .22 | portal-lt-app |

From the above it is clear that hostname with highest mean is the best property to name the application.

Embodiments of the present invention then call the Name generation layer which calculates the name of the application using both TF and TF-IDF matrix.

Once again, although various embodiments of the present application discovery invention described herein refer to embodiments of the present invention integrated within a virtual computing system with, for example, its corresponding set of functions, it should be understood that the embodiments of the present invention are well suited to not being integrated into an application discovery system and operating separately from an applications discovery system. Specifically, embodiments of the present invention can be integrated into a system other than a security system. Embodiments of the present invention can operate as a stand-alone module without requiring integration into another system. In such an embodiment, results from the present invention regarding feature selection and/or the importance of various machines or components of a computing environment can then be provided as desired to a separate system or to an end user such as, for example, an IT administrator.

Additionally, embodiments of the present invention provide a machine learning based application discovery system including a novel search feature for machines or components (including, but not limited to, virtual machines) of the computing environment. The novel search feature of the present machine learning based applications discovery system enables ends users to readily assign the proper and scopes and services the machines or components of the computing environment, Moreover, the novel search feature of the present machine learning based application discovery system enables end users to identify various machines or components (including, but not limited to, virtual machines) similar to given and/or previously identified machines or components (including, but not limited to, virtual machines) when such machines or component satisfy a particular given criteria. Hence, in embodiments of the present security system, the novel search feature functions by finding or identifying the “siblings” of various other machines or components (including, but not limited to, virtual machines) within the computing environment.

### CONCLUSION

The examples set forth herein were presented in order to best explain, to describe particular applications, and to thereby enable those skilled in the art to make and use embodiments of the described examples. However, those skilled in the art will recognize that the foregoing description and examples have been presented for the purposes of illustration and example only. The description as set forth is not intended to be exhaustive or to limit the embodiments to the precise form disclosed. Rather, the specific features and acts described above are disclosed as example forms of implementing the Claims.

Reference throughout this document to “one embodiment,” “certain embodiments,” “an embodiment,” “various embodiments,” “some embodiments,” “various embodiments”, or similar term, means that a particular feature, structure, or characteristic described in connection with that embodiment is included in at least one embodiment. Thus, the appearances of such phrases in various places throughout this specification are not necessarily all referring to the same embodiment. Furthermore, the particular features, structures, or characteristics of any embodiment may be combined in any suitable manner with one or more other features, structures, or characteristics of one or more other embodiments without limitation.

What is claimed:

1. A computer-implemented method for automated naming of an Application/Tier in a virtual computing environment, said method comprising:
automatically determining properties of members of said virtual computing environment;
performing a tokenization process on text corresponding to said members of said virtual computing environment to obtain information from said text corresponding to said members of said virtual computing environment;
utilizing a document generation operation to obtain tokens from said text corresponding to said members of said virtual computing environment;
performing a text mining operation on said text corresponding to said members of said virtual computing environment to obtain Term Frequency (TF) data, Document Frequency (DF) information, an Inverse Document Frequency (IDF), and TF-IDF data; and
utilizing said TF-IDF data to automatically generate and assign a name to said Application/Tier of said virtual computing environment.

2. The computer-implemented method of claim 1, wherein said tokenization process is performed using text mining techniques to obtain said information from said text corresponding to said members of said virtual computing environment.

3. The computer-implemented method of claim 1, wherein said tokenization process is performed using regular expression patterns to obtain said information from said text corresponding to said members of said virtual computing environment.

4. The computer-implemented method of claim 1, wherein said tokenization process is performed using commonly used separators to obtain said information from said text corresponding to said members of said virtual computing environment.

5. The computer-implemented method of claim 1, wherein said Term Frequency (TF) data is comprised of a frequency occurrence for a term t in a document d corresponding to said Application/Tier of said virtual computing environment.

6. The computer-implemented method of claim 1, wherein said Document Frequency (DF) information is comprised of a count of occurrences of a term tin a document set N corresponding to said Application/Tier of said virtual computing environment.

7. The computer-implemented method of claim 1, wherein said Inverse Document Frequency (IDF) is utilized to diminish/reduce the weight of terms that occur repeatedly in a document set document set N corresponding to said Application/Tier of said virtual computing environment.

8. The computer-implemented method of claim 7, wherein a log of said Inverse Document Frequency (IDF) is utilized to diminish/reduce the weight of terms that occur repeatedly in a document set document set N corresponding to said Application/Tier of said virtual computing environment.

9. The computer-implemented method of claim 1, wherein said TF data is utilized to determine a prefix portion of said name which is automatically generated and assigned to said Application/Tier of said virtual computing environment.

10. The computer-implemented method of claim 1, wherein said TF-IDF data is utilized to determine a suffix portion of said name which is automatically generated and assigned to said Application/Tier of said virtual computing environment.

11. The computer-implemented method of claim 1, wherein said utilizing said TF-IDF data to automatically generate and assign a name to said Application/Tier of said virtual computing environment is performed without requiring intervention by a system administrator

12. A computer-implemented method for automatically discovering and naming applications in an agentless plurality of diverse components in a computing environment said method comprising:
automatically generating component flow data;
automatically enriching said flow data with workload information pertaining to said plurality of diverse components to generate a connectivity graph wherein said connectivity graph includes one or more weakly connected components;
generating applications spanning across said plurality of diverse components. providing said results for said automated analysis of said features of said components;
creating a software defined network based upon the application boundary endpoints;
automatically determining properties of members of said virtual computing environment;
performing a tokenization process on text corresponding to said members of said virtual computing environment to obtain information from said text corresponding to said members of said virtual computing environment;
utilizing a document generation operation to obtain tokens from said text corresponding to said members of said virtual computing environment;
performing a text mining operation on said text corresponding to said members of said virtual computing environment to obtain Term Frequency (TF) data, Document Frequency (DF) information, an Inverse Document Frequency (IDF), and TF-IDF data; and
utilizing said TF-IDF data to automatically generate and assign a name to said Application/Tier of said virtual computing environment.

13. The computer-implemented method of claim 12, further comprising:
utilizing machine learning clustering and outlier detection based on statistics measures to detect boundaries of said plurality of applications.

14. The computer-implemented method of claim 13, further comprising
Generating said boundaries with said plurality of applications based on similarities in the pattern of host service endpoints and access service endpoints of said components to generate tiers of said plurality of applications of said computing environment.

15. The computer-implemented method of claim 12, wherein said machine learning cluster and outlier detection further comprises data normalization of to filter out said flow data.

16. The computer-implemented method of claim 15, wherein said machine learning cluster and outlier detection further comprises an application disconnection component for processing said normalized flow data to identify weakly connected components in said computing environment.

17. The computer-implemented method of claim 16, wherein said outlier detection detects said application outliers based on a number of incoming connections and a number of outgoing connections of said workload of said plurality of components in said computing environment.

18. The computer-implemented method of claim 12, wherein said TF data is utilized to determine a prefix portion of said name which is automatically generated and assigned to said Application/Tier of said virtual computing environment.

19. A computer-implemented method for automatically discovering and naming a group in a virtual computing environment said method comprising:
automatically generating component flow data;
automatically enriching said flow data with workload information pertaining to said plurality of diverse components to generate a connectivity graph wherein said connectivity graph includes one or more weakly connected components;
generating applications spanning across said plurality of diverse components. providing said results for said automated analysis of said features of said components;
creating a software defined network based upon the application boundary endpoints;
automatically determining properties of members of said virtual computing environment;
performing a tokenization process on text corresponding to said members of said virtual computing environment to obtain information from said text corresponding to said members of said virtual computing environment;
utilizing a document generation operation to obtain tokens from said text corresponding to said members of said virtual computing environment;
performing a text mining operation on said text corresponding to said members of said virtual computing environment to obtain Term Frequency (TF) data, Document Frequency (DF) information, an Inverse Document Frequency (IDF), and TF-IDF data; and
utilizing said TF-IDF data to automatically generate and assign a name to a group of said virtual computing environment.

20. The computer-implemented method of claim 19, wherein said method for automatically discovering and naming a group in a virtual computing environment is applicable in multi-cloud and hybrid cloud regardless of type of virtualization or vendor.
